(19) United States
(12) Patent Application Publication
(10) Pub. No.: US 2026/0228680 A1
(43) Pub. Date: Aug. 6, 2026

(54) ARTICLE PROVIDING SYSTEM, PRODUCT PROVIDING DEVICE, AND COMPUTER READABLE STORAGE MEDIUM

(71) Applicant: BANDAI CO., LTD., Tokyo (JP)

(72) Inventors: Satoshi SAKASAI, Tokyo (JP); Ryuya WATANABE, Tokyo (JP); Shinnosuke UGAWA, Tokyo (JP); Ryo INOUE, Tokyo (JP); Miyu KUROIWA, Tokyo (JP); Yoshie KOBAYASHI, Tokyo (JP); Konosuke KIRYU, Tokyo (JP); Retsu NAKANISHI, Tokyo (JP); Riko WATANABE, Tokyo (JP); Miyuki KIMURA, Tokyo (JP)

(21) Appl. No.: 19/458,897

(22) Filed: Jan. 25, 2026

(30) Foreign Application Priority Data
Jan. 31, 2025 (JP) 2025-015581

(51) Int. Cl. G06Q 10/0836; G06Q 30/0601

(52) U.S. Cl. CPC G06Q 10/0836; G06Q 30/0641

(57) ABSTRACT

An article providing system includes: a first acquisition unit which acquires position information of a user; a first presentation unit which presents a product; a provision unit which provides the product which is presented; and a control unit which controls the first acquisition unit, the first presentation unit, and the provision unit. The article providing system enables provision of the product when the user is located in a first region.

### BACKGROUND

### 1. Technical Field

The present invention relates to an article providing system, a product providing device, and a computer readable storage medium.

### 2. Related Art

Conventionally, there has been proposed an information providing system that outputs, from an information station device to a user, destination map information indicating a destination and position information for receiving special service information related to the destination together with the special service information (for example, Patent Document 1).

### Related Art Documents

### PATENT DOCUMENT

Patent Document 1: Japanese Patent Application Publication No. 2002-342654

### BRIEF DESCRIPTION OF THE DRAWINGS

FIG. 1 is a diagram illustrating an application example of an article providing system according to an embodiment.

FIG. 2 is a diagram illustrating an example of a configuration of an article providing system 1.

FIG. 3 is a diagram illustrating an example of a hardware configuration of a server 30.

FIG. 4 is a diagram illustrating an example of a product purchase screen displayed on a user terminal 40a of a user located outside a specific area 51.

FIG. 5 is a diagram illustrating an example of a product purchase screen displayed on a user terminal 40b of a user located within the specific area 51.

FIG. 6 is a diagram illustrating an example of a lottery screen displayed on the user terminal 40a of the user located outside the specific area 51.

FIG. 7 is a diagram illustrating an example of a lottery screen displayed on the user terminal 40b of the user located within the specific area 51.

FIG. 8 is a sequence diagram illustrating an operation example of the article providing system 1.

### DESCRIPTION OF EXEMPLARY EMBODIMENTS

Hereinafter, aspects of an article providing system, a product providing device, and a computer readable storage medium representing one aspect of the present invention will be described with reference to the drawings.

### Application Example of Article Providing System

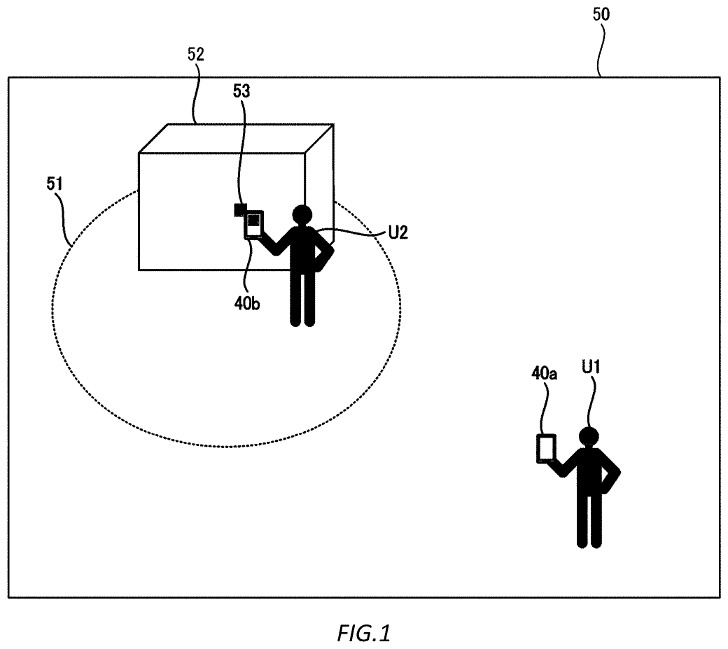

FIG. 1 is a diagram illustrating an application example of an article providing system according to an embodiment. The article providing system is a system capable of providing a specific product among a plurality of products (articles) to be provided while enhancing user amusement. As illustrated in FIG. 1, the article providing system can be applied to a predetermined region such as a theme park 50. When a user U1, U2 intends to purchase products by using the article providing system, purchasable products are limited by, for example, positions where the user U1, U2 is located.

In the theme park 50 illustrated in FIG. 1, the user U2 is located within a specific area 51 set in advance. The user U1 is located outside the specific area 51 of the theme park 50. The specific area 51 is an example of a “first region” of the present invention.

For example, a building 52 in the theme park 50 exists within the specific area 51 where the user U2 is located. The building 52 is an example of an “article” of the present invention.

In the building 52, for example, a vending machine (not illustrated) that enables purchase of a product related to the theme park 50 is installed, and a “two-dimensional code 53” is affixed to the vending machine. The two-dimensional code 53 is included in the building 52 arranged in the specific area 51. The vending machine presents the two-dimensional code 53. The vending machine is an example of a “second presentation unit” of the present invention. The two-dimensional code 53 is an example of “identification information” of the present invention.

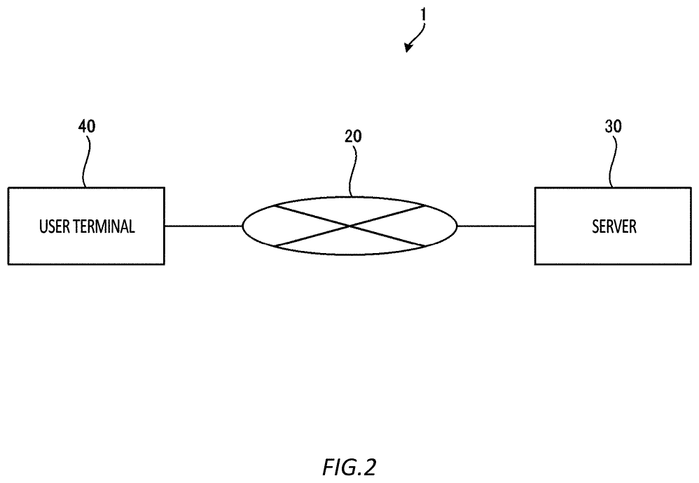

The user U1, U2 carries a user terminal 40a, 40b on which an imaging camera is mounted. The user terminal 40a, 40b can read the two-dimensional code 53 with the imaging camera. The user terminal 40a, 40b can transmit position information of the user terminal 40a, 40b to an external server 30 described later with reference to FIG. 2, by reading the two-dimensional code 53 with the imaging camera. It is possible to purchase a product based on the position information of the user terminal 40a, 40b.

In this example, the two-dimensional code 53 is affixed to the vending machine, but an object to which the two-dimensional code 53 is affixed is not limited thereto. For example, the two-dimensional code 53 may be affixed to a board, a column, or the like installed within the specific area 51. In addition, the two-dimensional code 53 may be displayed on a screen or projected, for example, at a venue within the specific area 51.

### Configuration of Article Providing System

FIG. 2 is a diagram illustrating an example of a configuration of the article providing system 1. As illustrated in FIG. 2, the article providing system 1 includes the server 30 and a user terminal 40. The server 30 and the user terminal 40 are communicably connected via a network 20. The server 30 is an example of a “first acquisition unit”, a “provision unit”, a “control unit”, and a “product providing device” of the present invention. The user terminal 40 is an example of a “first presentation unit” and a “second acquisition unit” of the present invention.

The server 30 acquires position information of the user from the user terminal 40. A term “acquiring position information” means that, when a world wide web (web) browser of the user terminal 40 accesses a server (electronic commerce (EC) site), the position information (global navigation satellite system (GNSS) information) of the user terminal 40 is acquired from an OS by using an application programming interface (API), and the acquired position information is included in a hypertext transfer protocol (HTTP) request of a product purchase page and transmitted to server 30. The server 30 provides a product presented by the user terminal 40. The “product” may be, for example, an article or digital content. The server 30 enables provision of a product depending on the position information of the user. The server 30 manages inventory, sales, and the like of a product to be provided, based on product information transmitted and received to and from the user terminal 40.

The user terminal 40 presents products. The products include a limited product that is an example of a “first type of product” of the present invention and a non-limited product that is an example of a “second type of product” of the present invention. The limited product is a product corresponding to the specific area 51. For example, a plurality of specific areas 51 are set in a predetermined region (such as the theme park 50) to which the article providing system 1 can be applied, and a limited product is associated with each specific area 51.

The user terminal 40 can present the limited product when the user is located in the specific area 51 and when the user is located outside the specific area 51. The limited product is presented also to the user terminal 40 located outside the specific area 51, but the relevant user cannot purchase the limited product.

The user terminal 40 may present lottery tickets instead of the products. The lottery tickets include a limited lottery ticket that is an example of a “first type of lottery ticket” of the present invention and a non-limited lottery ticket that is an example of a “second type of lottery ticket” of the present invention. The limited lottery ticket is a lottery ticket corresponding to the specific area 51.

The user terminal 40 can present the limited lottery ticket when the user is located in the specific area 51, and can present the non-limited lottery ticket when the user is located outside the specific area 51.

As a condition for purchasing the limited product, acquisition of identification information (two-dimensional code) may be used as the condition in addition to the condition of the region where the user is located. For example, in a case of the specific area 51 illustrated in FIG. 1, acquisition of the two-dimensional code 53 may be used as a condition for purchasing the limited product. The user terminal 40 can acquire the two-dimensional code 53 with, for example, a camera function. The user terminal 40 may be able to present the limited lottery ticket on condition of acquisition of the two-dimensional code 53.

### Hardware Configuration of Server

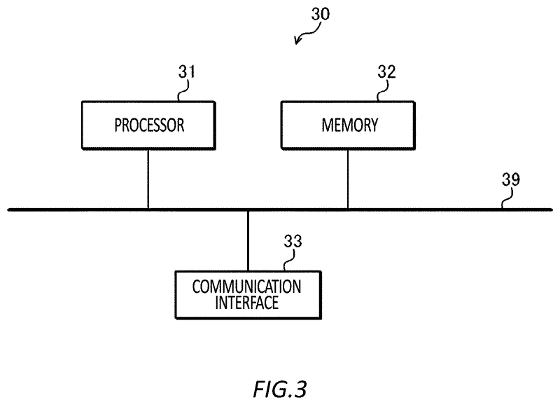

FIG. 3 is a diagram illustrating an example of a hardware configuration of the server 30. As illustrated in FIG. 3, the server 30 includes a processor 31, a memory 32, and a communication interface 33. The processor 31, the memory 32, and the communication interface 33 are connected by, for example, a bus 39.

The processor 31 is a circuit that performs signal processing, and is, for example, a central processing unit (CPU) that controls the entire server 30. Note that the processor 31 may be implemented by another digital circuit such as a field programmable gate array (FPGA) or a digital signal processor (DSP). In addition, the processor 31 may be implemented by combining a plurality of digital circuits. The server 30 and the processor 31 are examples of the “control unit” of the present invention.

The memory 32 includes, for example, a main memory and an auxiliary memory. The main memory is, for example, a random access memory (RAM). The main memory is used as a work area of the processor 31.

The auxiliary memory is, for example, a nonvolatile memory such as a magnetic disk, an optical disk, or a flash memory. The auxiliary memory stores various product providing programs for operating the server 30. The programs stored in the auxiliary memory are loaded into the main memory and executed by the processor 31.

In addition, the auxiliary memory may include a portable memory removable from the server 30. Examples of the portable memory include a memory card such as a universal serial bus (USB) flash drive or a secure digital (SD) memory card, an external hard disk drive, and the like.

The communication interface 33 is a communication interface that communicates with an outside (for example, the network 20) of the server 30. The communication interface 33 is controlled by the processor 31.

The processor 31 and the communication interface 33 acquire the position information of the user terminal 40 via the network 20. In addition, the processor 31 and the communication interface 33 transmit and receive the product information to and from the user terminal 40.

The server 30 can provide a product when the user is located in the specific area 51, and cannot provide the product when the user is located outside the specific area 51. The server 30 can provide the limited product only when the user is located in the specific area 51. In addition, the server 30 can provide the non-limited product when the user is located in the specific area 51 and when the user is located outside the specific area 51. The server 30 provides the non-limited product wherever the user is located.

The server 30 can provide the limited product to the relevant user on condition that the user terminal 40 has acquired the two-dimensional code 53.

The server 30 is provided with a payment system capable of accepting payment of consideration for a product to be purchased. The “payment system” is a system capable of accepting payment by the user terminal 40, and is, for example, a credit card payment system or the like. The payment system is an example of an “acceptance unit” of the present invention. The server 30 can provide the limited product or the non-limited product on condition of acceptance of the payment of consideration for the product.

The server 30 can set an upper limit on a provision count of the limited product, and does not set an upper limit on a provision count of the non-limited product. The “upper limit” is an upper limit of a purchase count per person (one account). The user can purchase any number of non-limited products, but an upper limit of a purchase count is determined for the limited product. In addition, the server 30 can limit a providable time for the limited product, and does not limit a providable time for the non-limited product. In addition to confirmation of the position information accompanied by access via the two-dimensional code, the server 30 also performs confirmation of an access time period. The server 30 does not provide the limited product at night, for example. Specifically, the server 30 does not provide the limited product outside business hours of the theme park 50.

The server 30 can provide a limited product of the product information corresponding to the limited lottery ticket on condition of selection of the limited lottery ticket, and can provide a non-limited product of the product information corresponding to the non-limited lottery ticket on condition of selection of the non-limited lottery ticket. The lottery ticket includes the product information randomly selected.

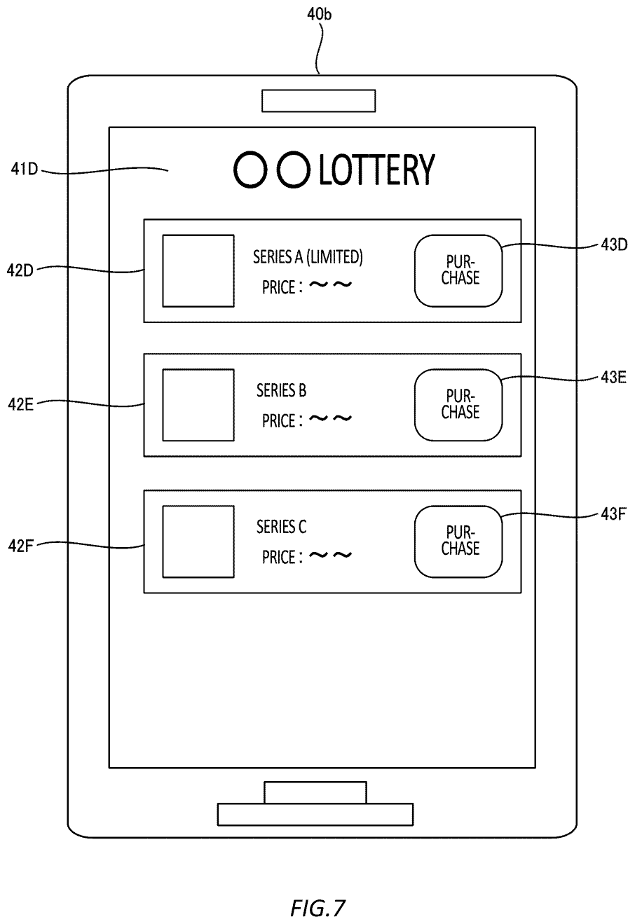

The server 30 can provide the limited product on condition that the limited lottery ticket is selected within a certain period of time after acquisition of the two-dimensional code 53. When the two-dimensional code 53 is read by the user terminal 40, the limited lottery ticket is presented to the user terminal 40, and thus, when the limited lottery ticket is selected within a certain period of time, the limited product is provided. Selecting a lottery ticket means, for example, tapping a purchase button (described later with reference to FIG. 7) for purchasing the limited product.

The server 30 can provide the product purchased by the user via delivery. The server 30 enables the delivery of the product based on user information input during product purchase, for example, an address, a name, a delivery date, and the like.

### Product Purchase Processing in Article Providing System

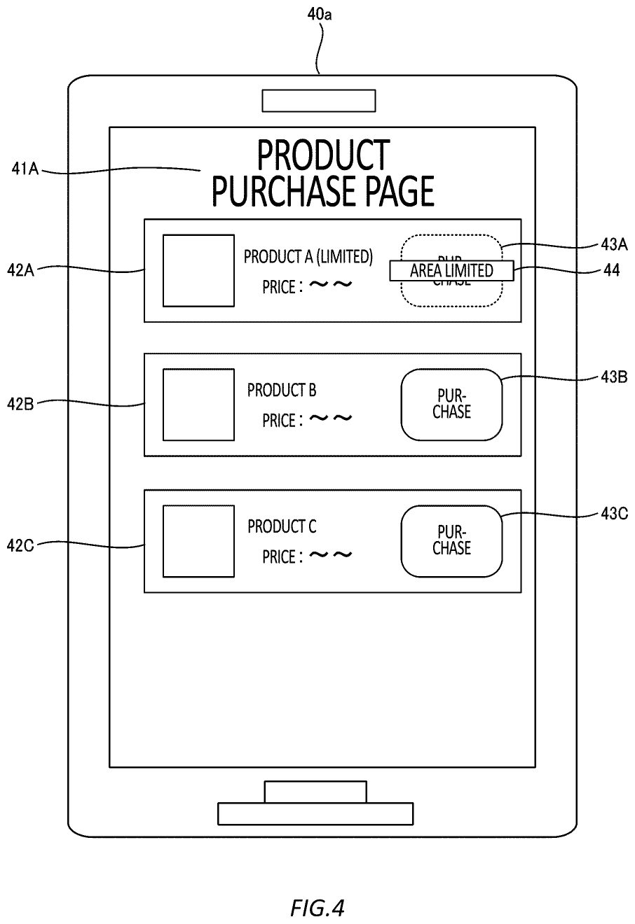

FIG. 4 is a diagram illustrating an example of a product purchase screen displayed on the user terminal 40a of the user located outside the specific area 51. For example, it is assumed that the user U1 carrying the user terminal 40a is located in a region other than the specific area 51 in the theme park 50 as illustrated in FIG. 1.

When the user U1 accesses the EC site via the user terminal 40a, the position information of the user U1 is transmitted from the user terminal 40a to the server 30. The server 30 recognizes the position of the user terminal 40a based on the received position information, and if the recognized position of the user terminal 40a is within the specific area 51 set in advance, transmits, to the user terminal 40a, a product purchase page (web page) which allows the purchase of the limited product. On the other hand, if the recognized position of the user terminal 40a is outside the specific area 51, the server 30 transmits, to the user terminal 40a, a product purchase page (web page) which does not allow the purchase of the limited product.

As described above, since the user U1 is in a region other than the specific area 51 in the theme park 50, a product purchase page 41A of the EC site which does not allow the purchase of the limited product as illustrated in FIG. 4 is transmitted from the server 30 to the user terminal 40a.

For example, product information 42A, 42B, and 42C is presented on the product purchase page 41A. The product information 42A is information regarding a product A. In the product information 42A, characters “limited” indicating that the product A is the limited product are displayed. As described above, the limited product is a product that can be provided when a user is located in a specific area. In addition, a price of the product A is displayed in the product information 42A. In addition, in the product information 42A, a “purchase” button 43A to be tapped when purchasing the product A is displayed in a non-tappable state. An “area-limited” label 44 is displayed in a superimposing manner on the “purchase” button 43A. The “area-limited” label 44 is a label for notifying a user located outside the specific area that the product cannot be purchased. The user U1 of the user terminal 40a is in a region other than the specific area 51. Therefore, the “area-limited” label 44 is superimposed on the “purchase” button 43A of the product A that is the limited product. Note that an image of a product may be displayed in each product information.

The product information 42B is information regarding a product B. A price of the product B is displayed in the product information 42B. In addition, in the product information 42B, a “purchase” button 43B to be tapped when purchasing the product B is displayed. The product B is not the limited product but the non-limited product. The product information 42C is information regarding a product C. In the product information 42C, a price of the product C and a “purchase” button 43C to be tapped when purchasing the product C are displayed. Similarly to the product B, the product C is the non-limited product. The user U1 located outside the specific area 51 can purchase the product B and the product C, which are the non-limited products, on the product purchase page 41A by using the user terminal 40a.

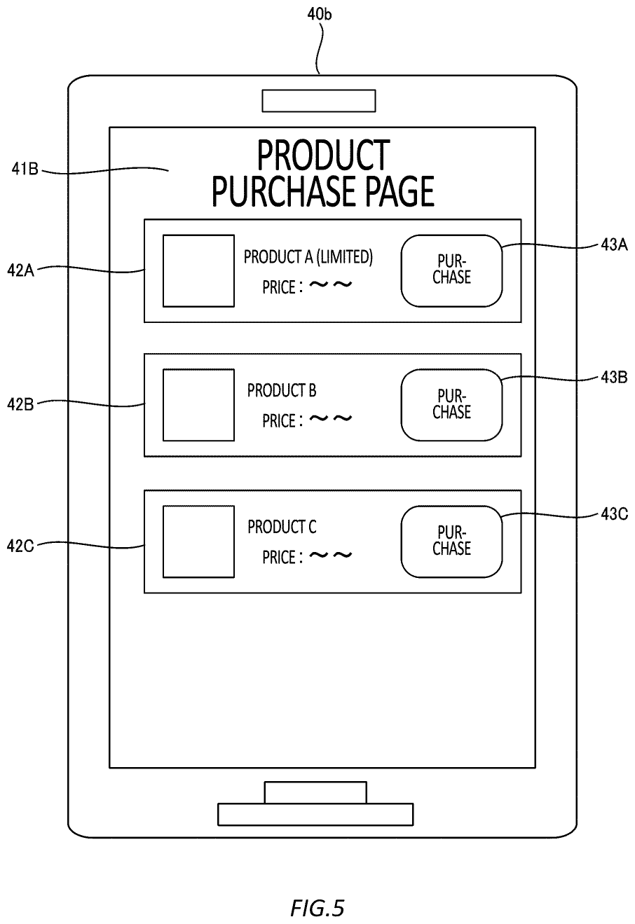

FIG. 5 is a diagram illustrating an example of a product purchase screen displayed on the user terminal 40b of the user located within the specific area 51. For example, it is assumed that the user U2 carrying the user terminal 40b is located in a region within the specific area 51 of the theme park 50 as illustrated in FIG. 1.

When the user U2 accesses the EC site via the user terminal 40b using a normal URI, the position information of the user U2 is transmitted from the user terminal 40b to the server 30. The server 30 recognizes the position of the user terminal 40b based on the received position information, and if the recognized position of the user terminal 40b is within the specific area 51 set in advance, transmits, to the user terminal 40b, the product purchase page (web page) which allows the purchase of the limited product. On the other hand, if the recognized position of the user terminal 40b is outside the specific area 51, the server 30 transmits, to the user terminal 40b, a product purchase page (web page) which does not allow the purchase of the limited product.

As described above, since the user U2 is in a region in the specific area 51 of the theme park 50, a product purchase page 41B of the EC site which allows the purchase of the limited product as illustrated in FIG. 5 is transmitted from the server 30 to the user terminal 40b.

For example, the product information 42A, 42B, and 42C is presented on the product purchase page 41B. The product information 42A is information regarding the product A. In the product information 42A, characters “limited” indicating that the product A is the limited product are displayed. In addition, the price of the product A is displayed in the product information 42A. In addition, in the product information 42A, the “purchase” button 43A to be tapped when purchasing the product A is displayed. The user U2 of the user terminal 40b is in a region within the specific area 51. Therefore, the user U2 can purchase the product A which is the limited product. Therefore, an “area-limited” label is not displayed on the “purchase” button 43A of the product A (limited).

The product information 42B is information regarding the product B. The price of the product B is displayed in the product information 42B. In addition, in the product information 42B, the “purchase” button 43B to be tapped when purchasing the product B is displayed. The product B is not the limited product but the non-limited product. The product information 42C is information regarding the product C. In the product information 42C, the price of the product C and the “purchase” button 43C to be tapped when purchasing the product C are displayed. Similarly to the product B, the product C is the non-limited product. The user U2 located within the specific area 51 can purchase the product A, which is the limited product, and the product B and the product C, which are the non-limited products, on the product purchase page 41B by using the user terminal 40b.

Access to the EC site may be performed using the two-dimensional code 53. For example, the user U2 may access the EC site by reading the two-dimensional code 53 affixed to the vending machine installed in the building 52 with the user terminal 40b. When the two-dimensional code 53 is read by the user terminal 40b, the EC site is accessed via a URI (URI with a specific parameter) different from a normal one. At that time, the position information of the user U2 is transmitted from the user terminal 40b to the server 30. The server 30 recognizes the position of the user terminal 40b based on the received position information, and if the recognized position of the user terminal 40b is within the specific area 51 set in advance and an access destination of the user terminal 40b is the “URI with a specific parameter”, transmits, to the user terminal 40b, the product purchase page (web page) which allows the purchase of the limited product.

As described above, the user U2 is in a region within the specific area 51 of the theme park 50. In addition, since the user U2 has read the two-dimensional code 53, the access destination of the user terminal 40b becomes the “URI with a specific parameter”. Therefore, the product purchase page 41B of the EC site which allows the purchase of the limited product as illustrated in FIG. 5 is transmitted from the server 30 to the user terminal 40b.

Next, processing will be described in which different types of lottery tickets are presented to the user terminal depending on a difference in a region where the user is located, and the user selects the lottery ticket to purchase a product.

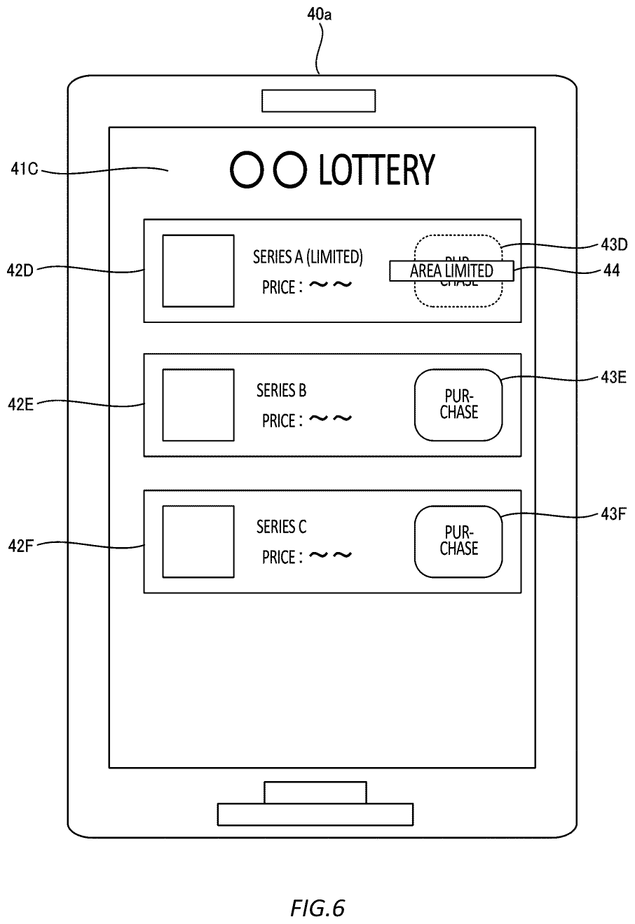

FIG. 6 is a diagram illustrating an example of a lottery screen displayed on the user terminal 40a of the user located outside the specific area 51. For example, similarly to a case described with reference to FIG. 4, it is assumed that the user U1 carrying the user terminal 40a is located in a region other than the specific area 51 in the theme park 50 as illustrated in FIG. 1.

When the user U1 accesses the EC site via the user terminal 40a, the position information of the user U1 is transmitted from the user terminal 40a to the server 30. The server 30 recognizes the position of the user terminal 40a, and if the position of the user terminal 40a is within the specific area 51, transmits, to the user terminal 40a, a ◯◯ lottery page (web page) which allows purchase of a lottery for the limited product. On the other hand, if the position of the user terminal 40a is other than the specific area 51, the server 30 transmits, to the user terminal 40a, a OO lottery page (web page) which does not allow the purchase of the lottery for the limited product. Allowing purchase of a lottery means enabling drawing of a lottery to be provided with an article or the like corresponding to a result of the drawing.

As described above, since the user U1 is in a region other than the specific area 51 in the theme park 50, a ◯◯ lottery 41C of the EC site which does not allow the purchase of the lottery for the limited product as illustrated in FIG. 6 is transmitted from the server 30 to the user terminal 40a.

For example, product information 42D, 42E, and 42F is presented in the ◯◯ lottery 41C. The product information 42D is information regarding a series A. In the product information 42D, characters “limited” indicating that the series A is a limited series are displayed. The limited series is a series that can be provided when a user is located in a specific area. In addition, a price of the series A is displayed in the product information 42D. In addition, in the product information 42D, a “purchase” button 43D to be tapped when purchasing the series A is displayed in a non-tappable state. The “area-limited” label 44 is displayed in a superimposing manner on the “purchase” button 43D. The “area-limited” label 44 is a label for notifying a user located outside the specific area that purchase is not available. The user U1 of the user terminal 40a is in a region other than the specific area 51. Therefore, the “area-limited” label 44 is superimposed on the “purchase” button 43D of the series A that is the limited series.

The product information 42E is information regarding a series B. In the product information 42E, a price of the series B and a “purchase” button 43E to be tapped when purchasing the series B are displayed. The series B is not the limited series but a non-limited series. The product information 42F is information regarding a series C. In the product information 42F, a price of the series C and a “purchase” button 43F to be tapped when purchasing the series C are displayed. Similarly to the series B, the series C is the non-limited series.

The user U1 located outside the specific area 51 can purchase the series B and the series C, which are the non-limited series, in the ◯◯ lottery 41C by using the user terminal 40a. For example, when the user U1 taps the “purchase” button 43E, draw processing is performed, and any character selected from among a plurality of characters included in the series B is won.

FIG. 7 is a diagram illustrating an example of a lottery screen displayed on the user terminal 40b of the user located within the specific area 51. For example, similarly to a case described with reference to FIG. 5, it is assumed that the user U2 carrying the user terminal 40b is located in a region in the specific area 51 of the theme park 50 as illustrated in FIG. 1.

When the user U2 accesses the EC site via the user terminal 40b using a normal URI, the position information of the user U2 is transmitted from the user terminal 40b to the server 30. The server 30 recognizes the position of the user terminal 40b, and if the position of the user terminal 40b is within the specific area 51, transmits, to the user terminal 40b, a ◯◯ lottery page (web page) which allows the purchase of the lottery for the limited product. On the other hand, if the position of the user terminal 40b is outside the specific area 51, the server 30 transmits, to the user terminal 40b, a ◯◯ lottery page (web page) which does not allow the purchase of the lottery for the limited product.

As described above, since the user U2 is in the region in the specific area 51 of the theme park 50, the ◯◯ lottery 41D of the EC site which allows the purchase of the lottery for the limited product as illustrated in FIG. 7 is transmitted from the server 30 to the user terminal 40b.

For example, the product information 42D, 42E, and 42F is presented in the ◯◯ lottery 41D. The product information 42D is information regarding the series A. In the product information 42D, characters “limited” indicating that the series A is the limited series are displayed. In addition, in the product information 42D, the price of the series A and the “purchase” button 43D to be tapped when purchasing the series A are displayed. The user U2 of the user terminal 40b is in a region within the specific area 51. Therefore, the user U2 can purchase the series A (limited) which is the limited series. Therefore, the “area-limited” label is not displayed on the “purchase” button 43D of the series A (limited).

The product information 42E is information regarding the series B. In the product information 42E, a price of the series B and the “purchase” button 43E to be tapped when purchasing the series B are displayed. The series B is not the limited series but the non-limited series. The product information 42F is information regarding the series C. In the product information 42F, the price of the series C and the “purchase” button 43F to be tapped when purchasing the series C are displayed. Similarly to the series B, the series C is the non-limited series.

The user U2 located within the specific area 51 can purchase the series A, which is the limited series, and the series B and the series C, which are the non-limited series, in the ◯◯ lottery 41D by using the user terminal 40b. For example, when the user U2 taps the “purchase” button 43D, the draw processing is performed, and any limited character selected from among a plurality of limited characters included in the series A is won.

Note that details of the draw processing is not limited to those in which, when each “purchase” button is tapped, any character of a plurality of characters included in the tapped series is won. For example, the draw processing may be such that, when the “purchase” button 43D of the series A, which is the limited series, among the series A, B, and C is tapped, a probability of winning a highly valuable limited character is high, and when the “purchase” buttons 43E and 43F of the series B and C, which are the non-limited series, are tapped, a probability of winning a normal character is high.

Access to the EC site may be performed using the two-dimensional code 53. For example, when the user U2 reads the two-dimensional code 53 with the user terminal 40b, the user U2 accesses the EC site with the URI with a specific parameter, and the position information of the user U2 is transmitted from the user terminal 40b to the server 30. If the position of the user terminal 40b is within the specific area 51 and the access destination is the “URI with a specific parameter”, the server 30 transmits, to the user terminal 40b, a ◯◯ lottery page (web page) which allows drawing a lottery for the limited product.

As described above, the user U2 is in a region within the specific area 51 of the theme park 50. In addition, since the user U2 has read the two-dimensional code 53, the access destination of the user terminal 40b becomes the “URI with a specific parameter”. Therefore, the ◯◯ lottery 41D of the EC site which allows the purchase of the lottery for the limited product as illustrated in FIG. 7 is transmitted from the server 30 to the user terminal 40b.

### Operation of Article Providing System

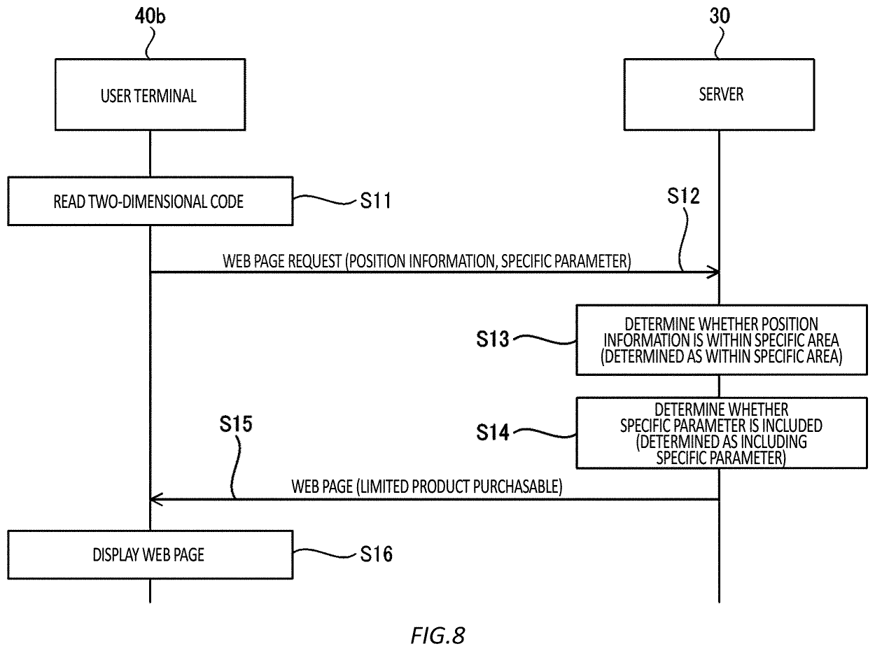

FIG. 8 is a sequence diagram illustrating an operation example of the article providing system 1. In the present operation example, a case will be described in which, in the theme park 50 illustrated in FIG. 1, the user U2 within the specific area 51 accesses the EC site by using the identification information (two-dimensional code) with the user terminal 40b.

First, the user terminal 40b reads the two-dimensional code 53 affixed to the vending machine installed in the building 52 (step S11). The user terminal 40b makes a web page request to the server 30 via the URI with a specific parameter stored in the two-dimensional code 53, with the position information of the user terminal 40b attached (step S12).

The server 30 determines whether or not the position of the user terminal 40b recognized from the position information included in the received web page request is within the specific area 51 set in advance (step S13). Here, since the user U2 carrying the user terminal 40b is within the specific area 51 as described above, the position information is determined to be within the specific area. In addition, the server 30 determines whether or not the specific parameter is included in the received web page request (step S14). Since the specific parameter stored in the two-dimensional code 53 is attached as in step S12, it is determined that the specific parameter is included. Since the position information is within the specific area and the specific parameter is attached, the server 30 transmits, to the user terminal 40, a web page where the limited product is purchasable (step S15).

The user terminal 40b displays, on a display screen, the web page transmitted from the server 30 (step S16). For example, the product purchase page 41B illustrated in FIG. 5 is displayed as an example of the web page on the user terminal 40b.

Thereafter, for example, in FIG. 5, when the “purchase” button 43A is tapped, purchase processing including payment is executed. Note that the server 30 may confirm the position information of the user terminal 40b again through communication in the purchase processing.

As described above, when position information of a user who intends to purchase a product is in a predetermined specific area, the article providing system 1 of the present aspect can provide a limited product that can be purchased only by the user in the specific area. According to this configuration, an article providing system can be provided which can enhance the user's product purchase motivation by allowing the user to purchase their favorite limited product when visiting the specific area and provide a high level of amusement.

In addition, the limited product is provided when the user is within the specific area, and the non-limited product is presented when the user is outside the specific area, so that the article providing system can be provided which can further enhance the user's product purchase motivation and provide a high level of amusement.

In addition, the article providing system 1 can provide the limited product on condition that the user acquires the two-dimensional code installed within the specific area. According to this configuration, the article providing system can be provided which increases the user's expectation that a special product can be purchased when reading the two-dimensional code, and provides a high level of amusement. In addition, by using not only the position information but also reading of the two-dimensional code as conditions for allowing the purchase of the limited product, it is possible to more accurately determine that the user is in the specific region, and to provide the limited product to an appropriate user. Further, by requiring not only reading of the two-dimensional code but also attachment of the position information, it is possible to prevent an act of copying the two-dimensional code to a third party and allowing the third party to purchase the limited product, and to provide the limited product to an appropriate user.

Note that a control method of the product providing device described in the above-described embodiment can be implemented by executing a product providing program prepared in advance on a computer. The present product providing program is recorded in a computer readable storage medium and is executed by being read from the storage medium. In addition, the present product providing program may be provided in a form stored in a non-transitory storage medium such as a flash memory, or may be provided via a network such as the Internet. The computer that executes the present product providing program may be included in the product providing device, may be included in electronic equipment such as a smartphone, a tablet terminal, or a personal computer that can communicate with the product providing device, or may be included in a server device that can communicate with the product providing device and the electronic equipment.

### EXPLANATION OF REFERENCES

1: article providing system;
20: network;
30: server;
31: processor;
32: memory;
33: communication interface;
39: bus;
40a, 40b: user terminal;
41A, 41B: product purchase page;
42A, 42B, 42C, 42D, 42E, 42F: product information;
43A, 43B, 43C, 43D, 43E, 43F: button;
44: label;
50: theme park;
51: specific area;
52: building;
53: two-dimensional code; and
U1, U2: user.

What is claimed is:

1. An article providing system comprising:
a first acquisition unit which acquires position information of a user;
a first presentation unit which presents a product;
a provision unit which provides the product which is presented; and
a control unit which controls the first acquisition unit, the first presentation unit, and the provision unit, wherein
provision of the product is enabled when the user is located in a first region.

2. The article providing system according to claim 1, wherein
the provision of the product is disabled when the user is located outside the first region.

3. The article providing system according to claim 1, wherein
the product includes a product of a first type and a product of a second type, and
provision of the product of the first type is enabled only when the user is located in the first region.

4. The article providing system according to claim 3, wherein
when the user is located in the first region and when the user is located outside the first region, provision of the product of the second type is enabled.

5. The article providing system according to claim 3, wherein
when the user is located in the first region and when the user is located outside the first region, presentation of the product of the first type is enabled.

6. The article providing system according to claim 3, wherein
the product of the first type is a product corresponding to the first region.

7. The article providing system according to claim 3, wherein
the product of the first type is a limited product, and the product of the second type is a non-limited product.

8. The article providing system according to claim 3, further comprising:
a second presentation unit which presents identification information in the first region; and
a second acquisition unit which is capable of acquiring the identification information, wherein
provision of the product of the first type is enabled on condition of acquisition of the identification information.

9. The article providing system according to claim 8, wherein
the identification information is included in an article arranged in the first region.

10. The article providing system according to claim 3, further comprising
an acceptance unit which is capable of accepting payment of consideration, wherein
provision of the product of the first type or the product of the second type is enabled on condition of acceptance of the payment of the consideration.

11. The article providing system according to claim 3, wherein
an upper limit is able to be set on a provision count of the product of the first type, and an upper limit is not set on a provision count of the product of the second type.

12. The article providing system according to claim 3, wherein
a providable time of the product of the first type is able to be limited, and a providable time of the product of the second type is not limited.

13. The article providing system according to claim 3, wherein
presentation of a lottery ticket of the first type is enabled when the user is located in the first region, and
presentation of a lottery ticket of the second type is enabled when the user is located outside the first region.

14. The article providing system according to claim 13, wherein
provision of the product of the first type of product information corresponding to the lottery ticket is enabled on condition of selection of the lottery ticket of the first type, and provision of the product of the second type of the product information corresponding to the lottery ticket is enabled on condition of selection of the lottery ticket of the second type.

15. The article providing system according to claim 13, wherein
the lottery ticket includes product information randomly selected.

16. The article providing system according to claim 8, further comprising:
a second presentation unit which presents identification information in the first region; and
a second acquisition unit which is capable of acquiring the identification information, wherein
presentation of a lottery ticket of the first type is enabled on condition of acquisition of the identification information, and
provision of the product of the first type is enabled on condition that the lottery ticket of the first type is selected within a certain period of time after the acquisition of the identification information.

17. The article providing system according to claim 1, wherein
the provision unit is capable of providing a product via delivery.

18. The article providing system according to claim 1, wherein
the product includes a product of a first type and a product of a second type,
provision of the product of the first type is enabled only when the user is located in the first region,
when the user is located in the first region and when the user is located outside the first region, provision of the product of the second type is enabled, and
when the user is located in the first region and when the user is located outside the first region, presentation of the product of the first type is enabled.

19. A product providing device comprising:
a first acquisition unit which acquires position information of a user;
a provision unit which provides a product presented by a first presentation unit which presents the product; and
a control unit which controls the first acquisition unit and the provision unit, wherein
provision of the product is enabled when the user is located in a first region.

20. A non-transitory computer readable storage medium having stored thereon a product providing program of a product providing device including a first acquisition unit which acquires position information of a user and a provision unit which provides a product presented by a first presentation unit which presents the product, wherein
the product providing program causes a processor of the product providing device to perform operations comprising
enabling provision of the product when the user is located in a first region.
